(19) United States
(12) Patent Application Publication
(10) Pub. No.: US 2017/0350325 A1
(43) Pub. Date: Dec. 7, 2017

(54) APPARATUS AND METHOD FOR CONTROLLING ENGINE HAVING VARIABLE VALVE ACTUATOR

(71) Applicant: HYUNDAI MOTOR COMPANY, Seoul (KR)

(72) Inventors: Dong Hee HAN, Seoul (KR); Jong Il PARK, Seoul (KR); Kwanhee CHOI, Seoul (KR); Hyungbok LEE, Seongnam-si (KR); Joowon LEE, Gwangju-si (KR); Dong Ho CHU, Ansan-si, (KR); Hyun Jun LIM, Incheon (KR)

(21) Appl. No.: 15/366,343

(22) Filed: Dec. 1, 2016

(30) Foreign Application Priority Data
Jun. 2, 2016 (KR) 10-2016-0068775

(51) Int. Cl. F02D 13/06; F02M 26/20; F02M 26/01; F02M 35/104; F02M 35/10

(52) U.S. Cl. CPC F02D 13/06; F02M 35/104; F02M 35/10268; F02M 26/01; F02M 26/20; F02M 35/10222

(57) ABSTRACT

An apparatus for controlling an engine having a variable valve actuator include: an engine including a plurality of cylinders generating a driving torque by burning fuel, an intake valve selectively opened for supplying air and the fuel to the cylinders through an intake manifold, and an exhaust valve selectively opened for exhausting exhaust gas generated from the cylinders to an exhaust manifold; a variable valve actuator disposed in at least one cylinder of the plurality of cylinders and adjusting lift and duration of the intake valve or the exhaust valve; and a controller deactivating the at least one cylinder of the plurality of cylinders through the variable valve actuator according to a driving region of the engine, and recirculating the exhaust gas exhausted from the cylinders into the intake manifold through the deactivated cylinder.

### CROSS-REFERENCE TO RELATED APPLICATION

This application claims the benefit of priority to Korean Patent Application No. 10-2016-0068775 filed in the Korean Intellectual Property Office on Jun. 2, 2016, the entire content of which is incorporated herein by reference.

### TECHNICAL FIELD

The present disclosure relates to an engine and a method for controlling an engine having a variable valve actuator. More particularly, the present disclosure relates to an engine and a method for controlling an engine having a variable valve actuator that operates deactivated cylinders as a pump for recirculating exhaust gas.

### BACKGROUND

Generally, nitrogen oxide (NOx) included in exhaust gas is a cause of acid rain, harms eyes and the respiratory organs, and withers plants. NOx is regulated as a major air pollutant and many researches have been carried out in order to reduce the amount of NOx in the exhaust gas.

An exhaust gas recirculation (EGR) system mounted in a vehicle reduces noxious exhaust gases of the vehicle. Generally, the amount of NOx in the exhaust gas is increased in an oxygen rich air mixture, and the air mixture is combusted well. Therefore, the exhaust gas recirculation system reduces the amount of NOx in the exhaust gas as a consequence of a part (e.g., 5-20%) of the exhaust gas being recirculated to the air mixture in order to reduce the oxygen ratio in the air mixture and so hinder combustion.

The general EGR system recirculates exhaust gas exhausted from a cylinder of the engine into the cylinder through an EGR line, and an EGR ratio is adjusted by an EGR valve is disposed in the EGR line.

The EGR system may be divided into a low pressure EGR (LP EGR) and a high pressure EGR (HP EGR).

Conventional EGR system recirculates exhaust gas to the cylinder of the engine through the EGR line, responsiveness is deteriorated when the EGR ratio is controlled by a controller, such as an engine control unit (ECU) of a vehicle.

Further, there is a problem that EGR gas cannot be supplied to the cylinder when a back pressure is greater than an intake pressure.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide an engine and a method for controlling an engine having a variable valve actuator having better responsiveness.

Further, the present disclosure has been made in an effort to provide an engine and a method for controlling the engine having a variable valve actuator that can supply EGR gas to the engine when a back pressure is greater than an intake pressure;

An apparatus for controlling an engine having a variable valve actuator according to an exemplary embodiment of the present disclosure includes: the engine including a plurality of cylinders generating a driving torque by burning fuel, an intake valve selectively opened for supplying air and the fuel to the plurality of cylinders through an intake manifold; an exhaust valve selectively opened for exhausting exhaust gas generated from the plurality of cylinders to an exhaust manifold; a variable valve actuator disposed in at least one cylinder among the plurality of cylinders and adjusting a valve characteristic of the intake valve and the exhaust valve; and a controller configured to deactivate the at least one cylinder of the plurality of cylinders through the variable valve actuator according to a driving region of the engine and to recirculate the exhaust gas exhausted from the plurality of cylinders into the intake manifold through the at least one deactivated cylinder;

The controller may recirculate exhaust gas to an activated cylinder by opening the exhaust valve of the deactivated cylinder during an intake stroke and opening the intake valve of the deactivated cylinder during an exhaust stroke.

The controller may control recirculated exhaust gas amount by adjusting a lift or duration of the exhaust valve and the intake valve through the variable valve actuator;

The controller may deactivate the at least one cylinder through the variable valve actuator and recirculate the exhaust gas to the activated cylinder through the at least one deactivated cylinder when the driving region of the engine is a low-speed and a low-load region.

A method for controlling an engine having a variable valve actuator according to another exemplary embodiment of the present disclosure includes deactivating, by a controller, at least one cylinder among a plurality of cylinders through a variable valve actuator based on a driving region of the engine; opening, by the controller, an exhaust valve of the at least one deactivated cylinder during an intake stroke; and opening, by the controller, an intake valve of the at least one deactivated cylinder during an exhaust stroke.

A recirculated exhaust gas amount may be adjusted by adjusting a lift or duration of the exhaust valve and the intake valve through the variable valve actuator.

When the driving region of the engine is a low-speed and a low-load region, at least one cylinder may be deactivated.

The intake manifold may integrally include a water to air intercooler.

According to the exemplary embodiment of the present disclosure, since EGR gas is directly supplied to an intake manifold, it is possible to improve responsiveness of EGR gas.

Further, since EGR gas is compressed by a piston and supplied to the intake manifold, it is possible to supply EGR gas to the engine when back pressure is greater than intake pressure (e.g., low-speed and high-load region).

### BRIEF DESCRIPTION OF THE DRAWINGS

The accompanying drawings are referenced merely to describe exemplary embodiments of the present invention, and therefore a technical spirit of the present invention is not to be construed to be limited to the accompanying drawings.

FIG. 1 is a schematic view illustrating an apparatus for controlling an engine having a variable valve actuator according to an exemplary embodiment of the present disclosure.

FIG. 2 is a block diagram illustrating an apparatus for controlling an engine having a variable valve actuator according to an exemplary embodiment of the present disclosure.

FIG. 3 to FIG. 6 are schematic views for explaining operation of an apparatus for controlling an engine having a variable valve actuator according to an exemplary embodiment of the present disclosure.

FIG. 7 is a graph illustrating a driving region of an engine according to an exemplary embodiment of the present disclosure.

FIG. 8 is a schematic view illustrating another apparatus for controlling an engine having a variable valve actuator according to an exemplary embodiment of the present disclosure.

FIG. 9 is a flowchart illustrating a method for controlling an engine having a variable valve actuator according to an exemplary embodiment of the present disclosure.

### DETAILED DESCRIPTION OF THE EMBODIMENTS

The present disclosure will be described more fully hereinafter with reference to the accompanying drawings, in which exemplary embodiments of the invention are shown. As those skilled in the art would realize, the described embodiments may be modified in various different ways, all without departing from the spirit or scope of the present disclosure.

Accordingly, the drawings and description are to be regarded as illustrative in nature and not restrictive. Like reference numerals designate like elements throughout the specification.

In addition, the size and thickness of each configuration shown in the drawings are arbitrarily shown for better understanding and ease of description, but the present disclosure is not limited thereto. In the drawings, the thickness of layers, films, panels, regions, etc., are exaggerated for clarity.

Hereinafter, an apparatus for controlling an engine having variable valve actuator according to an exemplary embodiment of the present disclosure will be described in detail with reference to accompanying drawings.

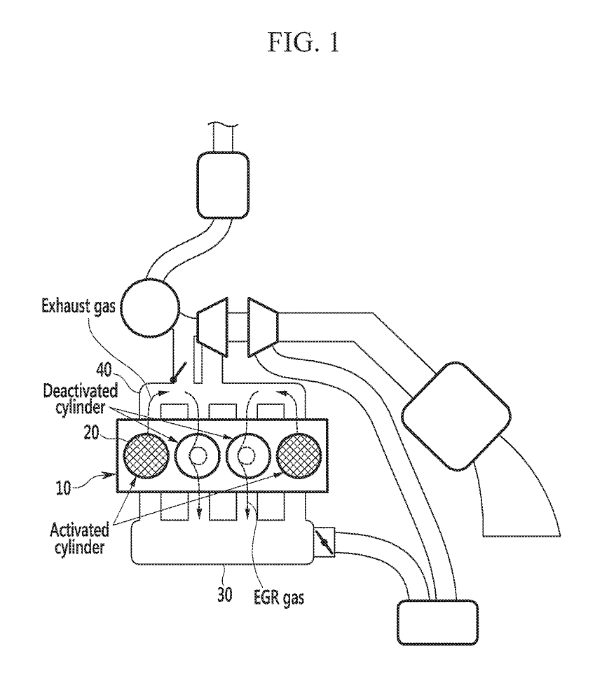

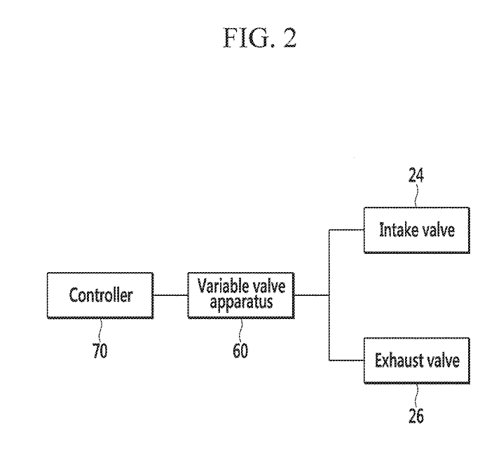

FIG. 1 is a schematic view illustrating an apparatus for controlling an engine having a variable valve actuator according to an exemplary embodiment of the present disclosure. FIG. 2 is a block diagram illustrating an apparatus for controlling an engine having a variable valve actuator according to an exemplary embodiment of the present disclosure.

As shown in FIGS. 1 and 2, an engine 10 having a variable valve actuator 60 according to an exemplary embodiment of the present disclosure includes a plurality of cylinders 20 in which an intake valve 24 and an exhaust valve 26 are disposed, a variable valve actuator 60 adjusting a lift and a duration of the intake valve 24 and exhaust valve 26, and a controller 70 operation of the engine 10, the variable valve actuator 60, the intake valve, and the exhaust valve 26.

The plurality of cylinders 20 generate driving torque by burning fuel.

The intake valve 24 is selectively opened for supplying air and fuel to the cylinder 20. An operation of the intake valve 24 is controlled by the controller 70. That is, the intake valve 24 is opened during an intake stroke for supplying air and fuel into the cylinder 20, and is closed during an exhaust stroke.

The exhaust valve 26 is selectively opened for exhausting exhaust gas. An operation of the exhaust valve 26 is controlled by the controller 70. That is, the exhaust valve 26 is closed during the intake stroke, and is opened during the exhaust stroke for exhausting exhaust gas generated from the cylinder 20. The variable valve actuator 60 is disposed at some of the cylinders, and selectively deactivates some of the cylinders. When the variable valve actuator 60 is operated, fuel is not supplied to a deactivated cylinder.

The opening timing and the closing timing of the intake valve 24 and the exhaust valve 26 are operated by rotation of a crankshaft, and the variable valve actuator 60 advances or retards the opening timing and the closing timing by the controller 70. And the variable valve actuator 60 adjusts lift of the intake valve 24 and the exhaust valve 26 by the controller 70. And the variable valve actuator 60 increases or decreases opening time and closing time (hereinafter, refer to ‘duration’) of the intake valve 24 and the exhaust valve 26 by the controller 70.

In an exemplary embodiment of the present disclosure, the variable valve actuator 60 includes a cylinder deactivation apparatus (CDA) deactivating the cylinder 20, a variable valve lift (VVL) device adjusting lift of the valves, a variable valve timing (VVT) device adjusting the opening timing and the closing timing of the valves, and a variable valve duration (VVD) device adjusting the duration of the valves.

The variable valve actuator 60 is widely known in the art, so that a more detailed description thereof will not be presented in the present specification. The controller 70 may be implemented by one or more processors operated by a predetermined program, in which the predetermined program is set to perform steps of the charge method for controlling the engine having the variable valve actuator 60 according to an exemplary embodiment of the present disclosure.

The controller 70 deactivates some cylinders 20 of the plurality of cylinders 20 through the variable valve actuator 60 according to a driving region of the engine 10, and recirculates exhaust gas exhausted from the activated cylinder 20 to an intake manifold 30 through the deactivated cylinder.

An operation of the variable valve actuator 60, an operation of the engine 10, and the opening and the closing of the intake valve 24 and the exhaust valve 26 are controlled by a control signal of the controller 70.

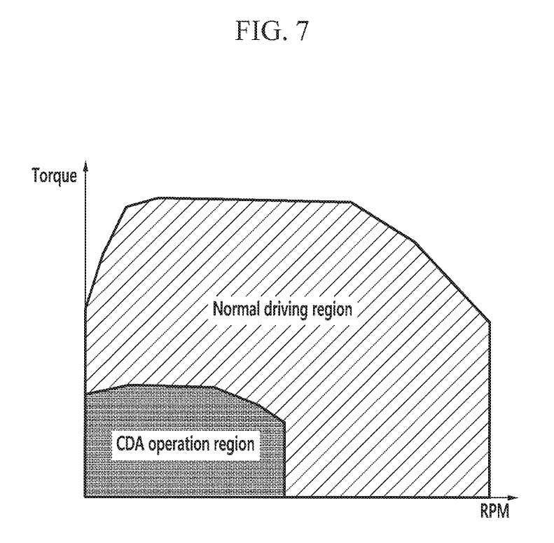

In detail, the controller 70 deactivates the some cylinders among the plurality of cylinders through the variable valve actuator 60 and recirculates exhaust gas through the deactivated cylinder when the driving region is a low-speed and a low-load region (refer to CDA operation region of FIG. 7). If the cylinder 20 is deactivated, fuel is not injected into the deactivated cylinder. Therefore, it is possible to improve fuel consumption and minimize pumping loss when the some cylinders are deactivated in the low-speed and the low-load region.

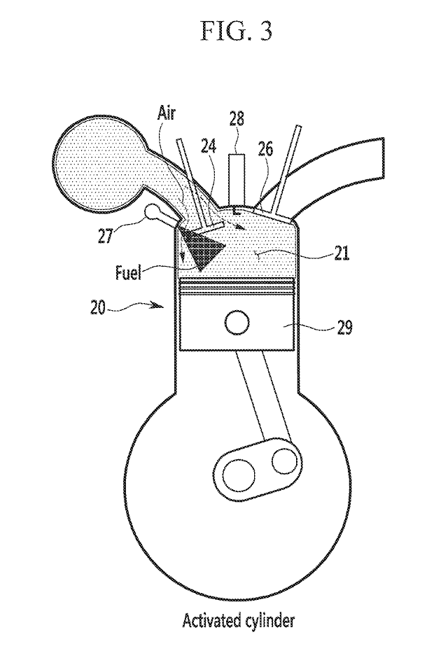

Referring to FIG. 3 to FIG. 6, a recirculation process of exhaust gas during a deactivation mode that the some cylinders are deactivated will be described in detail.

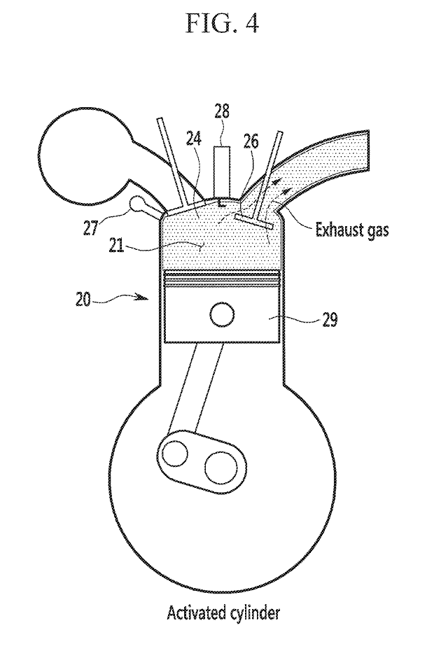

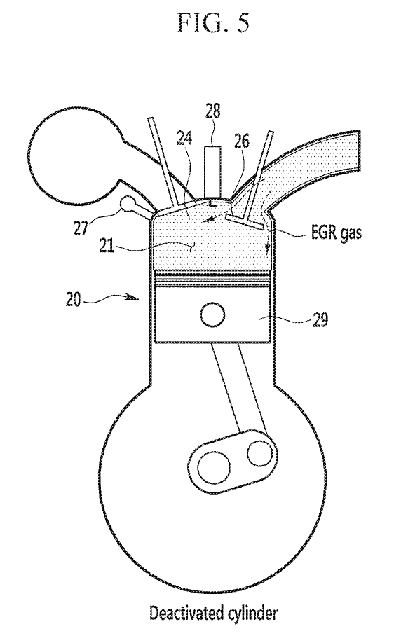

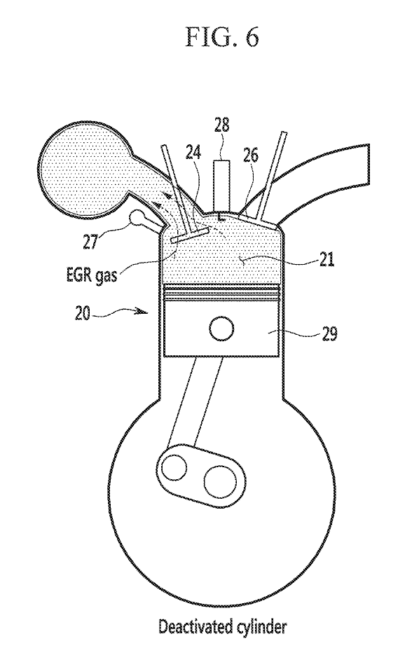

FIG. 3 shows an intake stroke of an activated cylinder in a deactivation mode, FIG. 4 shows an exhaust stroke of an activated cylinder in a deactivation mode, FIG. 5 shows an intake stroke of a deactivated cylinder in a deactivation mode, and FIG. 6 shows an exhaust stroke of a deactivated cylinder in a deactivation mode.

As shown in FIG. 3 and FIG. 4, the activated cylinder is normally operated in the deactivation mode. That is, the intake valve 24 is opened during the intake stroke, air flows into the cylinder 20, and fuel is injected into the activated cylinder by an injector 27. Fuel injected into the activated cylinder is ignited by a spark plug 28 during a compress stroke. Then, after an explosion stroke, the exhaust valve 26 is opened during an exhaust stroke, and exhaust gas generated at the activated cylinder is exhausted to the exhaust manifold 40.

As shown in FIG. 5 and FIG. 6, air and fuel are not supplied to the deactivated cylinder in the deactivation mode, the exhaust valve 26 is opened and the intake valve 24 is closed through the variable valve actuator 60 controlled by the controller 70. At this time, exhaust gas exhausted from the activated cylinder flows into the deactivated cylinder 20 through the exhaust manifold 40.

Since air is not supplied to the deactivated cylinder and fuel is not injected into deactivated cylinder, exhaust gas flowing into the deactivated cylinder is compressed during the compress stroke. The intake valve 24 is opened and the exhaust valve 26 is closed through the variable valve actuator 60 controlled by the controller 70 during the exhaust stroke. Since the intake valve 24 is opened during the compress stroke, compressed exhaust gas is exhausted to the intake manifold 30.

Then, the compressed exhaust gas exhausted to the intake manifold 30 is supplied to the activated cylinder 20 during the intake stroke.

At this time, the recirculated exhaust gas amount may be adjusted through the lift and the duration of the intake valve 24 and exhaust valve 26. In the deactivation mode, exhaust gas exhausted from the activated cylinder is resupplied to the activated cylinder through the deactivated cylinder, the deactivated cylinder functions as an exhaust gas recirculation (EGR) apparatus. The deactivated cylinder functions as a kind of a pump when exhaust gas is recirculated through the deactivated cylinder.

As such, since exhaust gas exhausted from the activated cylinder is recirculated to the activated cylinder through the deactivated cylinder, it is possible to obtain faster response performance.

Further, since exhaust gas is compressed by the piston 29 during exhaust gas recirculation process, it is possible to supply EGR gas to the activated cylinder when back pressure is greater than intake pressure (e.g., low-speed and low-load region).

Further, when exhaust gas exhausted from the activated cylinder is recirculated to the activated cylinder through the deactivated cylinder 20 in the deactivation mode, since exhaust gas and engine coolant are heat-exchanged with each other during the compress stroke and the explosion stroke, it is possible to cool EGR gas.

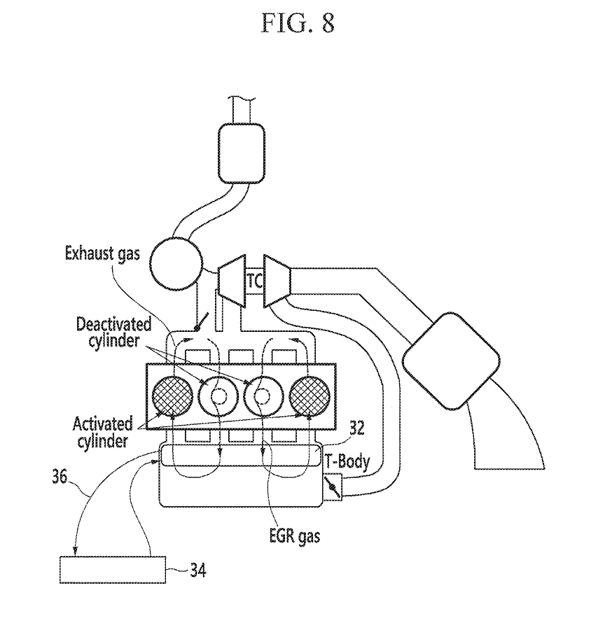

Referring to FIG. 8, the intake manifold 30 may integrally has a water to air intercooler 32. Heated coolant at the water to air intercooler 32 is cooled at a radiator 34 passing through a cooling line 36. As such, if the water to air intercooler 32 integrally includes the intake manifold 30, cooling performance of the recirculated exhaust gas can be improved when the exhaust gas is recirculated through the deactivated cylinder 20.

Hereinafter, a method for controlling an engine having the variable valve actuator according to an exemplary embodiment of the present disclosure will be described in detail with reference to accompanying drawings.

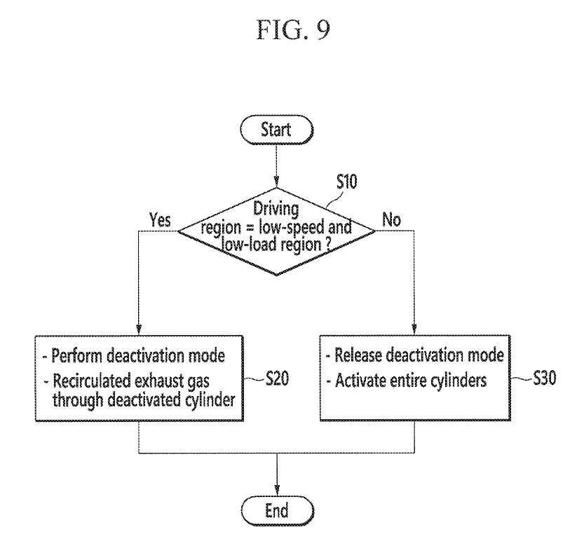

FIG. 9 is a flowchart illustrating a method for controlling an engine having a variable valve actuator according to an exemplary embodiment of the present disclosure.

As shown in FIG. 9, the controller 70 determines the driving region of the engine 10 at step S10. The driving region of the engine 10 may be determined from the required torque of the driver and engine speed.

When it is determined that the driving region of the engine 10 is the low-speed and the low-load region, the controller 70 performs the deactivation mode that the some cylinders in the plurality of cylinders are deactivated through the variable valve actuator 60 at step 320.

The controller 70 recirculates exhaust gas exhausted from the activated cylinder to the activated cylinder through the deactivated cylinder at step 320. The recirculation process of exhaust gas is the same as the above description.

When the driving region of the engine 10 is not the low-speed and the low-load region at step the S10, the controller 70 activates entire cylinders, and thus, exhaust gas is not recirculated through the deactivated cylinder at step 330.

While this invention has been described in connection with what is presently considered to be practical exemplary embodiments, it is to be understood that the invention is not limited to the disclosed embodiments, but on the contrary, is intended to cover various modifications and equivalent arrangements included within the spirit and scope of the appended claims.

What is claimed is:

1. An apparatus for controlling an engine having a variable valve actuator, the apparatus comprising:
an engine including a plurality of cylinders for generating a driving torque by burning fuel, an intake valve selectively opened for supplying air and the fuel to the plurality of cylinders through an intake manifold, and an exhaust valve selectively opened for exhausting exhaust gas generated from the plurality of cylinders to an exhaust manifold;
a variable valve actuator disposed in at least one cylinder among the plurality of cylinders and adjusting a valve characteristic of the intake valve and the exhaust valve; and
a controller configured to deactivate the at least one cylinder among the plurality of cylinders through the variable valve actuator according to a driving region of the engine and to recirculate the exhaust gas exhausted from the plurality of cylinders into the intake manifold through the at least one deactivated cylinder.

2. The apparatus of claim 1, wherein
the controller recirculates the exhaust gas to an activated cylinder by opening the exhaust valve of the at least one deactivated cylinder during an intake stroke and opening the intake valve of the at least one deactivated cylinder during an exhaust stroke.

3. The apparatus of claim 1, wherein
the controller controls a recirculated exhaust gas amount by adjusting a lift or duration of the exhaust valve and the intake valve through the variable valve actuator.

4. The apparatus of claim 1, wherein
the controller deactivates the at least one cylinder of the plurality of cylinders through the variable valve actuator and recirculates the exhaust gas to the activated cylinder through the at least one deactivated cylinder when the driving region of the engine is a low-speed and a low-load region.

5. A method for controlling an engine having a variable valve actuator; the method comprising steps of;
deactivating, by a controller, at least one cylinder of a plurality of cylinders through a variable valve actuator based on a driving region of the engine;
opening, by the controller, an exhaust valve of the at least one deactivated cylinder during an intake stroke; and
opening, by the controller, an intake valve of the at least one deactivated cylinder during an exhaust stroke.

6. The method of claim 5, wherein
an recirculated exhaust gas amount is adjusted by adjusting a lift or duration of the exhaust valve and the intake valve through the variable valve actuator.

7. The method of claim 5, wherein
when the driving region of the engine is a low-speed and a low-load region, the at least one of the plurality of cylinders is deactivated.

8. The method of claim 1, wherein
the intake manifold integrally includes a water to air intercooler.
